(19) United States
(12) Patent Application Publication
(10) Pub. No.: US 2003/0029389 A1
(43) Pub. Date: Feb. 13, 2003

(54) Disposable raingear for dogs

(76) Inventor: Joseph S. Sporn, New York, NY (US)

Correspondence Address: Hopgood, Calimafde, Judlowe & Mondolino, Suite 4100, 60 East 42nd Street, New York, NY, 10165, US

(21) Appl. No.: 09/923,930

(22) Filed: Aug. 7, 2001

(51) Int. Cl. A01K 13/00

(52) U.S. Cl. 119/850

(57) ABSTRACT

A disposable raincoat for pets, and primarily for dogs, provides effective, thin, lightweight, flexible, and inexpensive protection from the elements. The rain coat covers most of the animal, with the exception of the legs, snout, and tail. This allows the dog to have the freedom to run and play in inclement weather, while reducing the unpleasant odor that can emanate from a wet dog.

### BACKGROUND

1. Field of Invention.

The instant invention relates to disposable garments for animals. More particularly, this invention relates to a disposable raincoat for dogs.

2. State of the Art

People go to great lengths and expense in keeping up with the latest fashions and trends. Nevertheless, before fashion became such a large part of everyday life, garments were worn primarily for protection from the elements. As the human race began to settle regions having colder and wetter climates, protective garments became as essential as food; our survival depended on it.

The rest of the animal kingdom has gone without such accouterments. Lacking our ability to devise and construct wearable protection against their environment, other animal species have either evolved the protection necessary for survival, or simply died out. A wolf's fur is a perfect example of an animal's adaptive skin covering providing it with the natural ability to survive in cold and wet climates.

It is believed that man domesticated the wolf (Canis lupus) more than 12,000 years ago. Since then, dogs (Canis familiaris) have played an important role in the history of human civilization. Prehistoric and ancient illustrations depict dogs as man's hunting partner. The social nature of the canine fit perfectly with the social nature of the hunter-gatherer, which made it the perfect companion, along with the dog's keen sense of sight, sound, and smell, which made it the perfect hunting partner.

With the domestication of livestock, dogs were used as herders, as well as protectors from wild animals, such as their cousin the wolf. Over the centuries man has bred a wide range of dogs specially suited to serve a variety of functions. Today, there are more than 400 distinct breeds of dogs, ranging from the Great Dane, which stands more than 30 inches at the shoulders and can weigh more than 200 pounds, to the Chihuahua, which can weigh less than 6 pounds.

While dogs today still serve as hunting companions and livestock herders/protectors in many parts of the world, in urban and suburban environments most serve simply as loving companions. This is especially true in the United States and Europe, where pets are treated as members of the family.

Anyone who has had a dog knows well the problems of keeping its natural odor to a minimum. This is especially true with the larger and long-haired breeds. It is not only impractical to wash a dog every day, but it is also detrimental to the dog's skin and coat. The odor problem is especially evident when dogs get wet. While there are worse odors in the world, the smell of a wet dog is definitely not a pleasant one, not even for the most enthusiastic dog lover.

Naturally, it is impractical to keep dogs at home when it rains. Dogs, especially the larger variety, need to go out at least twice a day for urination, defecation, and exercise. Some people may simply attempt to hold a large umbrella over the dog, but this, too, is impractical. In recent years, manufacturers have begun making raincoats specially designed for dogs. These raincoats are generally made from heavy plastic with a cotton liner. While somewhat effective, it is impossible to keep a dog completely dry. Dogs run through puddles and wet grass, kicking up water and mud. Over time the raincoat becomes soiled and develops that wet dog smell, which the raincoat was intended to eliminate in the first place.

### OBJECTS AND SUMMARY OF THE INVENTION

Accordingly, it is an object of the present invention to provide an effective raincoat for dogs.

It is a further object of the present invention to provide a disposable raincoat for dogs.

These and other objects of the present invention will be apparent in the following description.

The present invention provides a disposable rain covering for dogs, comprising a rear portion extending dorsally and laterally, so as to cover the rump area of a dog; a middle portion extending dorsomedially and dorsoventriolaterally, so as to cover the back and belly of the dog; a shoulder portion extending dorsoventral laterally, so as to cover the shoulder, neck, and chest of the dog; and preferably a head portion, so as to cover the head of the dog.

One aspect of the present invention provides straps, flaps, or both for covering, at least partially, the belly and/or chest of the dog.

Another aspect of the present invention provides a strap for securing the head portion to the head of the dog.

### BRIEF DESCRIPTION OF THE FIGURES

FIG. 1 depicts a top plan view of the disposable dog raincoat of the present invention.

FIG. 2 depicts a side view of the disposable dog raincoat of FIG. 1 as it would be worn by a dog.

FIG. 3 depicts a top plan view of another aspect of the disposable dog raincoat of the present invention.

FIG. 4 depicts a side view of the disposable dog raincoat of FIG. 3 as it would be worn by a dog.

### DETAILED DESCRIPTION

The present invention provides a novel method and apparatus for overcoming the problem of soiled and smelly raincoats for dogs. By providing a thin, lightweight, and inexpensive disposable raincoat for dogs, it is possible to achieve the benefits of a standard raincoat for dogs while avoiding the drawbacks. The present invention provides the same protection from the elements as the standard model, but because it is disposable, it is discarded before it develops the wet dog smell.

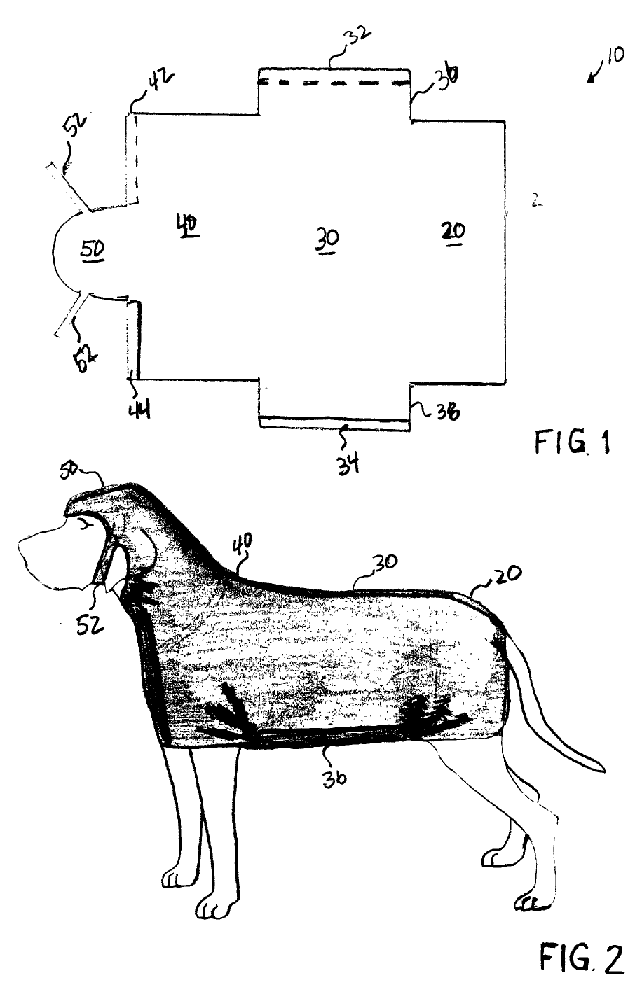

With reference now to the figures and, in particular, with reference to FIGS. 1 and 2, there is depicted a representation of a disposable dog raincoat 10 of the present invention. In particular, the disposable dog raincoat is preferably made from a single solid sheet of polyurethane, polyethylene, an ethylene or a propylene-containing polymer, or a similar ethylene or vinylidene polymer flexible or plasticized as necessary, so as to be useful for this invention. This material is inexpensive, lightweight, and naturally water-repellant, and can be printed, molded, or embossed with a pattern. This material preferably has a thickness from about 0.005 mm to about 0.12 mm, more preferably from about 0.02 mm to about 0.08 mm, and most preferably in the range of about 0.04 mm, depending on handleability of the material, including the amount of stretching (orientation) the sheet has undergone, in either the longitudinal or transverse direction, if any, the degree of plasticization, and the like. Thus the sheet can be made of a wide variety of materials, and in different thicknesses (e.g., a thicker material may be more desirable for colder climate), to the extent that the material is suitable for use as described herein. The rear portion 20 covers the rump of the dog, while still permitting convenient urination and excretion, regardless of the gender. The mid-portion 30 extends from the rear portion and comfortably covers the back and sides of the dog, and preferably wrapps around to cover at least a portion of the belly of the dog. The mid-portion extends dorsoventrally in a bilateral manner into two opposing flaps 36, 38. Each flap has a respective adhesive strip 32,34 for engaging the other flap across the belly of the dog. The adhesive strips may also be replaced by other functional equivalents, including for example only, and not limited to, hook and loop strips, zippers, snaps, buttons, magnets, etc. Naturally, as this raincoat is disposable, the least expensive engaging device is preferred.

The shoulder portion 40 extends dorsoventrally from the mid-portion and comfortably covers the shoulders, neck and chest. The laterally distal end of the shoulder portion in relation to the mid-portion includes opposable adhesive strips 42, 44 in order to engage the two distal ends of the shoulder portion for a comfortable and effective covering across the chest of the dog. These adhesive strips can be the same as the adhesive strips of the flaps of the mid-portion, or any other functional equivalent.

The head portion 50 extends dorsomedially from the shoulder portion and comfortably extends over the head of the dog. The head portion can be shaped in the form of a hood, or alternatively extend laterally into one or two head straps 52. These head straps can be tied together underneath the head of the dog, thereby securing the head portion to the dog. Alternatively, one or more of the head straps may include adhesive strips. These adhesive strips can be the same as the previously-mentioned adhesive strips, plain strips with loops or slits in opposing flaps, two strips for tying, or any other functional equivalent.

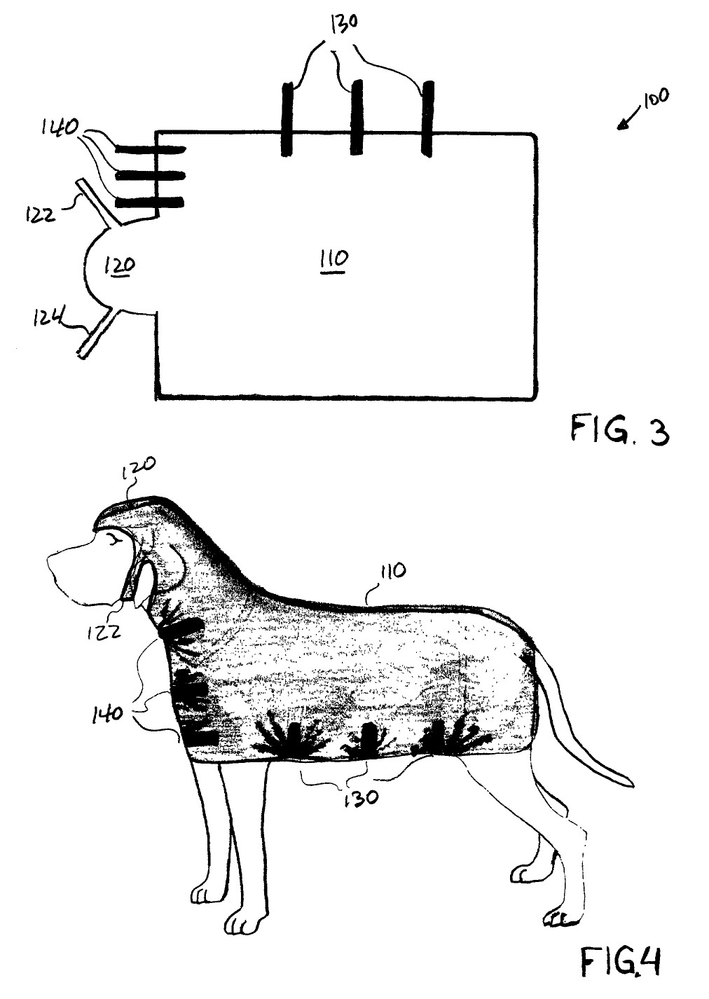

In another aspect of the present invention, as depicted in FIGS. 3 and 4, is a disposable raincoat 100. This aspect of the present invention simply includes a body portion 110 that covers and extends from the rump to the shoulders of the dog. The rear section of the body portion covers the rump of the dog, while still permitting convenient urination and excretion, regardless of the gender. The middle section of the body portion extends from the rear section and at least partially covers the back and belly of the dog. The middle section of the body portion includes at least one belly strip 130 positioned comparably to the position of either or both of the two flaps of FIGS. 1 and 2. Thus providing at least a partial covering for the belly of the dog by drawing together the two lateral sides of the middle section. The strips may be also replaced by other functional equivalents as discussed in relation to FIGS. 1 and 2.

The shoulder section of the body portion extends from the middle section and comfortably covers the shoulders, neck and chest. The distal end of the shoulder section in relation to the middle section includes at least one adhesive strip 140 in order to engage the two opposable portions of the shoulder section for a comfortable and effective covering around the chest of the dog. These strips can be the same as the strips of the opposable flaps of the middle section, or any other functional equivalent.

The head portion 120 extends from the shoulder portion and comfortably covers the head of the dog. The head portion can be shaped in the form of a hood, or alternatively extend laterally into one or two head straps 122. These head straps can be tied together underneath the head of the dog thereby securely covering the head of the dog. One or both of the straps may include an adhesive portion to secure the head portion to the head of the dog. These adhesive strips can be the same as the adhesive strips of the flaps of the mid-portion, or any other functional equivalent.

The present invention is not only specifically directed to an animal having physical characteristics that are different than those of a human being, but also psychological and behavioral characteristics as well. It must be clear that most dogs will not stand still when they know that they are about to be taken outside. They become extremely excited and active. This makes it difficult to put a collar on a dog, let alone a raincoat. The present invention has been made in accordance with these special considerations and characteristics. Not only is the invention effective in attaining the result for which it was intended, but it is also effective in the convenience and relative ease of its utilization.

The use of the term “consisting essentially of” is meant to exclude components and materials, such as liners, complicated metal clasps, multi-piece construction, and the like, that would increase the cost of the coat and thereby reduce the incentive for having only a single use of the device. Of course, “single use” should read to mean a rather limited number of uses, generally not more than about 5 days, more preferably not more than about 3 days, and most preferably about 2 days before the garment is significantly less useful than it was intended to be when new.

The forgoing description is meant to be illustrative and not limiting. Various changes, modifications, and additions may become apparent to the skilled artisan upon perusal of this specification, and such are meant to be within the scope and spirit of the invention as defined by the claims.

What is claimed is:

1. A disposable rain covering for dogs, comprising:
a. a rear portion extending laterally, so as to cover the rump area of a dog;
b. a middle portion extending laterally, so as to cover the back and belly of the dog; and
c. a shoulder portion extending laterally, so as to cover the shoulder, neck, and chest of the dog.

2. The disposable rain covering for dogs of claim 1, further comprising a head portion, so as to cover the head of the dog.

3. The disposable rain covering for dogs of claim 1, wherein said middle portion further comprises at least one lateral end, so as to cover the belly of the dog.

4. The disposable rain covering for dogs of claim 1, wherein said shoulder portion further comprises at least one leading end, so as to cover the chest of the dog.

5. The disposable rain covering for dogs of claim 2, wherein said head portion further comprises a hood.

6. The disposable rain covering for dogs of claim 2, further comprising means for securing said head portion to the head of the dog.

7. The disposable rain covering for dogs of claim 1, further comprising means for covering the belly of the dog.

8. The disposable rain covering for dogs of claim 1, further comprising means for covering the chest of the dog.

9. The disposable rain covering for dogs of claim 1, further comprising at least one strap for securing said mid portion around the belly of the dog.

10. The disposable rain covering for dogs of claim 1, further comprising at least one strap for securing said shoulder portion around the chest of the dog.

11. The disposable rain covering for dogs of claim 2, further comprising at least one strap for securing said head portion over the head of the dog.

12. The disposable rain covering for dogs of claim 1, wherein the rear, middle, and shoulder portions comprise an integral piece of material selected from the group consisting of polyethylene, polyurethane, ethylene polymer, propylene polymer, and vinylidene polymer.

13. The disposable rain covering for dogs of claim 1, wherein the material of which said portions are constructed has a thickness of less than 0.12 mm.

14. The disposable rain covering for dogs of claim 1, wherein the material of which said portions are constructed has a thickness of greater than 0.005 mm.

15. The disposable rain covering for dogs of claim 1, wherein the material of which said portions are constructed has a thickness of approximately 0.04 mm.

16. A disposable rain covering for dogs, consisting essentially of:
a. a rear portion extending laterally, so as to cover the rump area of a dog;
b. a middle portion extending laterally, so as to cover the back and belly of the dog; and
c. a shoulder portion extending laterally, so as to cover the shoulder, neck, and chest of the dog.

17. The disposable rain covering for dogs of claim 16, further consisting of a head portion, so as to cover the head of the dog.

18. The disposable rain covering for dogs of claim 16, further consisting of at least one strap for securing said mid portion around the belly of the dog.

19. The disposable rain covering for dogs of claim 16, further consisting of at least one strap for securing said shoulder portion around the chest of the dog.

20. The disposable rain covering for dogs of claim 17, further consisting of at least one strap for securing said head portion over the head of the dog.
